(19) United States
(12) Patent Application Publication
(10) Pub. No.: US 2004/0181438 A1
(43) Pub. Date: Sep. 16, 2004

(54) System and method for dynamic seat allocation

(76) Inventors: Keith Hoene, Boise, ID (US); Robert Sesek, Meridian, ID (US); Michael J. Shelton, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/389,446

(22) Filed: Mar. 14, 2003

(51) Int. Cl. G06F 17/60

(52) U.S. Cl. 705/5

(57) ABSTRACT

A system and method for dynamic seat allocation is disclosed. In one embodiment, the invention is a system for dynamically allocating seat assignments, comprising a matrix having a plurality of available seats, a first seating arrangement using fewer than the entire plurality of available seats, the first seating arrangement based on a first seating request, a subsequent seating request, and logic for revising the first seating arrangement to develop a proposed seating arrangement to accommodate the first seating request and the second seating request.

### BACKGROUND OF THE INVENTION

Many event tickets today are purchased electronically via, for example, the Internet. For example, it is possible to purchase tickets for sporting events, musical concerts, or virtually any other event electronically over the Internet, or via the telephone.

Conventional ticket reservation systems, such as seat reservation at an event held at a stadium, allow the purchaser to select the exact seat at the point of sale and reserve that seat when the purchase is completed. Unfortunately, as tickets for that particular event continue to sell, the available seating becomes fragmented as reserved seats surround a small number of unsold seats, many of which are single seats. These single isolated seats are difficult to sell. Thus, this process potentially reduces the total number of seats that may be sold for the event.

Therefore, it would be desirable to minimize the number of unsold seats at an event.

### BRIEF DESCRIPTION OF THE DRAWINGS

The present invention, as defined in the claims, can be better understood with reference to the following drawings. The components within the drawings are not necessarily to scale relative to each other, emphasis instead being placed upon clearly illustrating the principles of the present invention.

FIG. 1 is a schematic view illustrating an exemplary environment in which the invention resides.

FIG. 2 is a block diagram illustrating an embodiment of the server of FIG. 1.

FIG. 3 is a flow chart illustrating an example of the operation of a first embodiment of the dynamic seat allocation software of FIG. 2.

FIG. 4 is a flow chart illustrating an example of the operation of the dynamic seat allocation software of FIG. 2.

FIGS. 5A through 5C are graphical illustrations collectively illustrating three scenarios that describe the results obtained by the dynamic seat allocation software of FIG. 2.

FIG. 6 is a schematic diagram illustrating an example of an alternative embodiment of the dynamic seat allocation software of FIG. 2.

### DETAILED DESCRIPTION OF THE INVENTION

The system and method for dynamic seat allocation can be implemented in software (e.g., firmware), hardware, or a combination thereof. In one embodiment, the system and method for dynamic seat allocation is implemented in a combination of hardware and software. In one embodiment, the invention is primarily software that is implemented on a computer.

Regardless of the manner of implementation, the software portion of the invention can be executed by a special or general-purpose computer, such as a personal computer (PC, IBM-compatible, Apple-compatible, or otherwise), workstation, minicomputer, or mainframe computer.

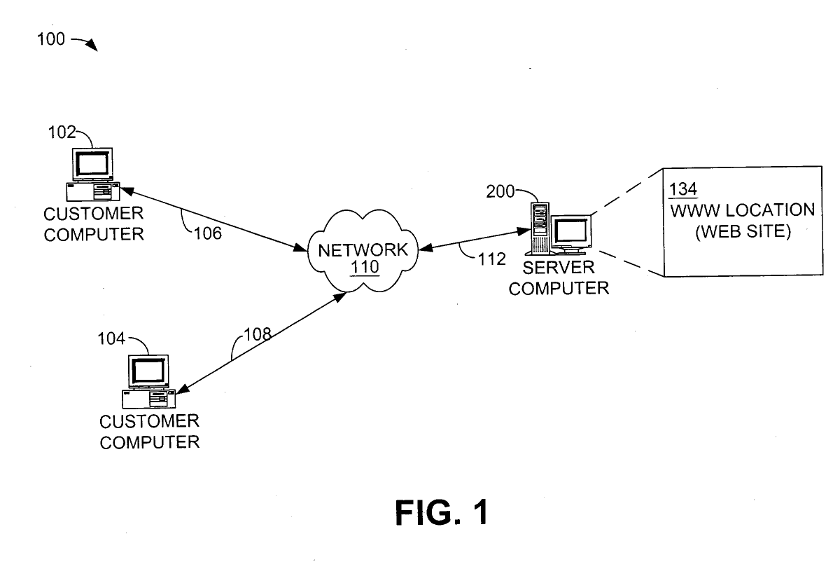

FIG. 1 is a schematic view illustrating an exemplary environment 100 in which the invention resides. As mentioned above, in one embodiment, the system and method for dynamic seat allocation is implemented primarily in software using a server computer 200 to which at least one other computer is connected. For example, a computer 102, which can be, for example, a personal computer, is coupled to the server computer 200 via a network 110. The network 110 may be a local area network (LAN), such as an office network, or may be a wide area network (WAN) such as the Internet. Furthermore, the network 110 may be a wireless network. In this embodiment, the computer 102 and the server computer 200 are connected to the network 110 via connections 106 and 112, respectively.

The computer 102 may be a personal computer located at, for example, a residence and the connection 106 can be any connection for coupling the computer 102 to the network 110. In a typical implementation, the network 110 is the Internet and the connection 106 is a dial-up connection, or possibly a broadband communication channel, such as a digital subscriber line (DSL) connection, or other high-speed connection.

The server computer 200, which can be similar to the computer 102, is typically a dedicated computer that is coupled to the network 110 via a high-speed connection 112, and that maintains, or is coupled to, a world wide web (WWW) location 134. In this embodiment, the server computer 200 may be coupled to a WWW location 134 for purchasing access to events, such as sporting events, or musical concerts.

Furthermore, additional computers, such as computer 104, may be coupled to the network 110 via connection 108. While illustrated as only two computers 102 and 104 coupled to the network 110, many additional computers and server computers may be coupled to the network 110.

The server computer 200 comprises software that allows an individual to electronically purchase entrance (i.e., tickets) to events by accessing the server computer 200 via the network 110. However, in a conventional system, when a ticket is purchased, the seat for the event is assigned at the time of purchase, and a ticket is either mailed to the purchaser via conventional mail, or the ticket is left at the event venue for customer pickup. Regardless of the manner in which the ticket is transferred to the purchaser, the seat is assigned at the time of purchase. Unfortunately, this generally results in a large number of seats for an event being unsold because the seating becomes fragmented as purchased seats surround a small number of unsold seats. Frequently, the unsold seats are “single” seats, resulting in these seats remaining unsold.

As will be described below, the server computer 200 includes dynamic seat allocation software that allows the seating assignments to remain flexible right up until the event. The dynamic seat allocation software dynamically rearranges the seating selection as additional tickets are purchased, thus allowing unsold seats to remain available in blocks larger than one seat. As will be described below, when a customer purchases a ticket from a system that implements the dynamic seat allocation software, the customer is provided a “seat reservation,” and not a ticket having an assigned seat. The seat reservation may be in the form of a barcode identification that the user prints at their own computer. This allows the dynamic seat allocation software the ability to reconfigure the available seating to minimize the number of unsold seats. For example, at the time of purchase, the customer would request a preferred seating arrangement (such as all seats in the same row, or the seats divided between two rows) to ensure that all members of the purchaser's party sit together in the final seating arrangement. The seat locations for members of the purchaser's party remain flexible until a final configuration is presented. When a subsequent request for tickets arrives at the server computer 200, the dynamic seat allocation software analyzes the “reserved” seats and dynamically reassigns the seats, or reorganizes the seating plan, to accommodate the original request and the subsequent request, if possible. However, if a purchaser decides at the time of purchase to select a reserved seat, then the customer can be given this choice at the time of purchase, and seats sold in this mode will not be available for dynamic reassignment.

In an alternative embodiment, the seat locations remain flexible up until the time of the event. In such an embodiment, the customer receives a receipt at the time of purchase. The receipt may include, for example, a barcode, or other electronically readable identification. When the customer arrives at the event venue, the receipt can be read by a reader at the venue and a seat location assigned at that time. In this manner, the system can dynamically optimize the seating for an event right up until the start of the event, thus minimizing the number of unsold seats.

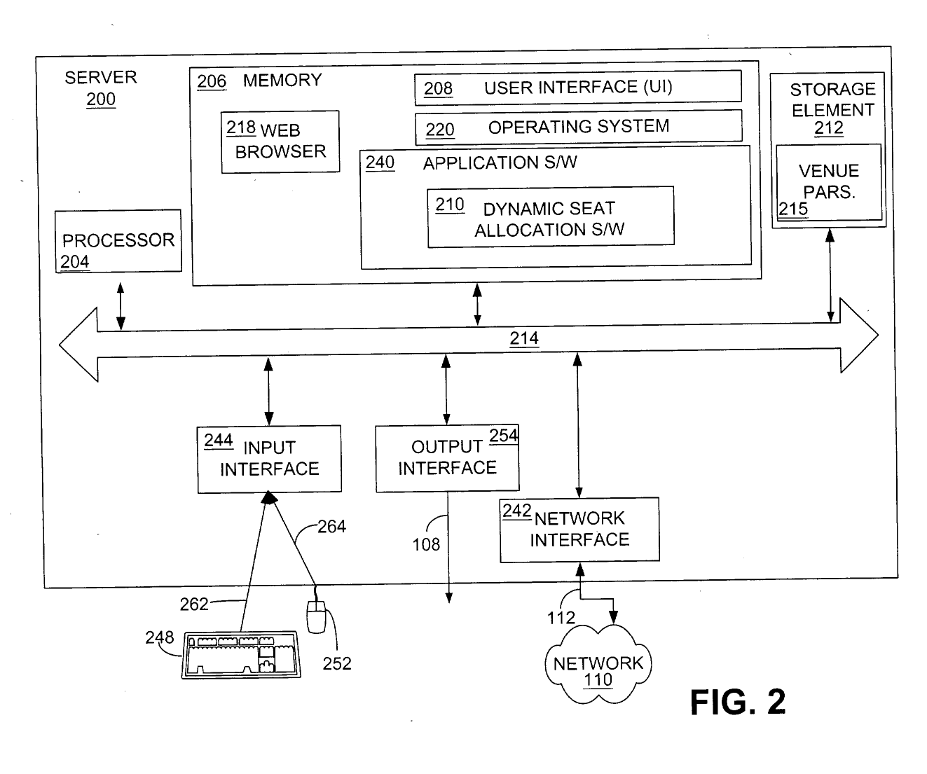

FIG. 2 is a block diagram illustrating an exemplary server computer 200 of FIG. 1. The server computer 200 can implement the dynamic seat allocation software 210. The dynamic seat allocation software 210 and other software and hardware elements (to be discussed with respect to FIG. 2) work in unison to implement the functionality of the invention.

Generally, in terms of hardware architecture, as shown in FIG. 2, the server computer 200 includes a processor 204, memory 206, a storage element 212, an input interface 244, an output interface 254 and a network interface 242 that are connected together and can communicate with each other via a local interface 214. The local interface 214 can be, for example but not limited to, one or more buses or other wired or wireless connections, as is known to those having ordinary skill in the art. The local interface 214 may have additional elements, which are omitted for simplicity, such as buffers (caches), drivers, and controllers, to enable communications. Further, the local interface 214 includes address, control, and data connections to enable appropriate communications among the above-mentioned components.

The processor 204 is a hardware device for executing software that can be stored in memory 206. The processor 204 can be any custom made or commercially available processor, a central processing unit (CPU) or an auxiliary processor among several processors associated with the server computer 200, and a microchip-based microprocessor or a macroprocessor.

The memory 206 can include any one or combination of volatile memory elements (e.g., random access memory (RAM, such as DRAM, SRAM, etc.)) and nonvolatile memory elements (e.g., ROM, hard drive, tape, CDROM, etc.). Moreover, the memory 206 may incorporate electronic, magnetic, optical, and/or other types of storage media. Note that the memory 206 can have a distributed architecture, where various components are situated remote from one another, but accessible by the processor 204.

The input interface 244 can receive commands from, for example, keyboard 248 via connection 262 and from mouse 252 via connection 264 and transfer those commands over the local interface 214 to the processor 204 and the memory 206.

The network interface 242 can be, for example, a network interface card (NIC) located in the server computer 200 or a modulator/demodulator (modem), or can be any communication device capable of connecting the server computer 200 to an external network 110.

The storage element 212 can be, for example, a disk drive having non-volatile storage capacity. The storage element 212 further includes venue parameters 215. The venue parameters 215 are typically the seating charts for any venue for which a seating assignment may be made by the server computer 200. Further, a single venue may include a variety of different parameters, depending upon the particular event. For example, at a single venue, a sporting event may have a different seating plan, and therefore different venue parameters, than a musical concert held at the same venue. As will be described below, the dynamic seat allocation software 210 interacts with the venue parameters to dynamically reconfigure the seating available at a particular venue for a particular event to minimize the number of unsold seats.

The software in memory 206 may include one or more separate programs, each of which comprises an ordered listing of executable instructions for implementing logical functions. In the example of FIG. 2, the software in the memory 206 includes the dynamic seat allocation software 210, a user interface (Ul) 208, a web browser 218, application software 240 and a suitable operating system (O/S) 220.

The operating system 220 essentially controls the execution of other computer programs, such as the dynamic seat allocation software 210 and the application software 240, and provides scheduling, input-output control, file and data management, memory management, and communication control and related services. The processor 204 and operating system 220 define a computer platform, for which application programs, such as the dynamic seat allocation software 210 and the application software 240 are written. The dynamic seat allocation software 210 includes the software that allows the server computer 200 to dynamically assign and reassign seats for an event.

If the server computer 200 is a PC, the software in the memory 206 further includes a basic input output system (BIOS) (omitted for simplicity of illustration). The BIOS is a set of software routines that test hardware at startup, start the O/S 220, and support the transfer of data among the hardware devices. The BIOS is stored in ROM so that it is accessible for execution when the server computer 200 is activated.

When the server computer 200 is in operation, the processor 204 is configured to execute software stored within the memory 206, to communicate data to and from the memory 206 and to generally control operations of the server computer 200 pursuant to the software. The dynamic seat allocation software 210 and the O/S 220, in whole or in part, but typically the latter, are read by the processor 204, perhaps buffered within the processor 204, and then executed.

When the system and method for dynamic seat allocation is implemented primarily in software, as is shown in FIG. 2, it should be noted that the dynamic seat allocation software 210 can be stored on any computer-readable medium for use by or in connection with any computer related system or method. In the context of this document, a computer-readable medium is an electronic, magnetic, optical, or other physical device or means that can contain or store a computer program for use by or in connection with a computer related system or method. The dynamic seat allocation software 210 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The hardware components of the system and method for dynamic seat allocation can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

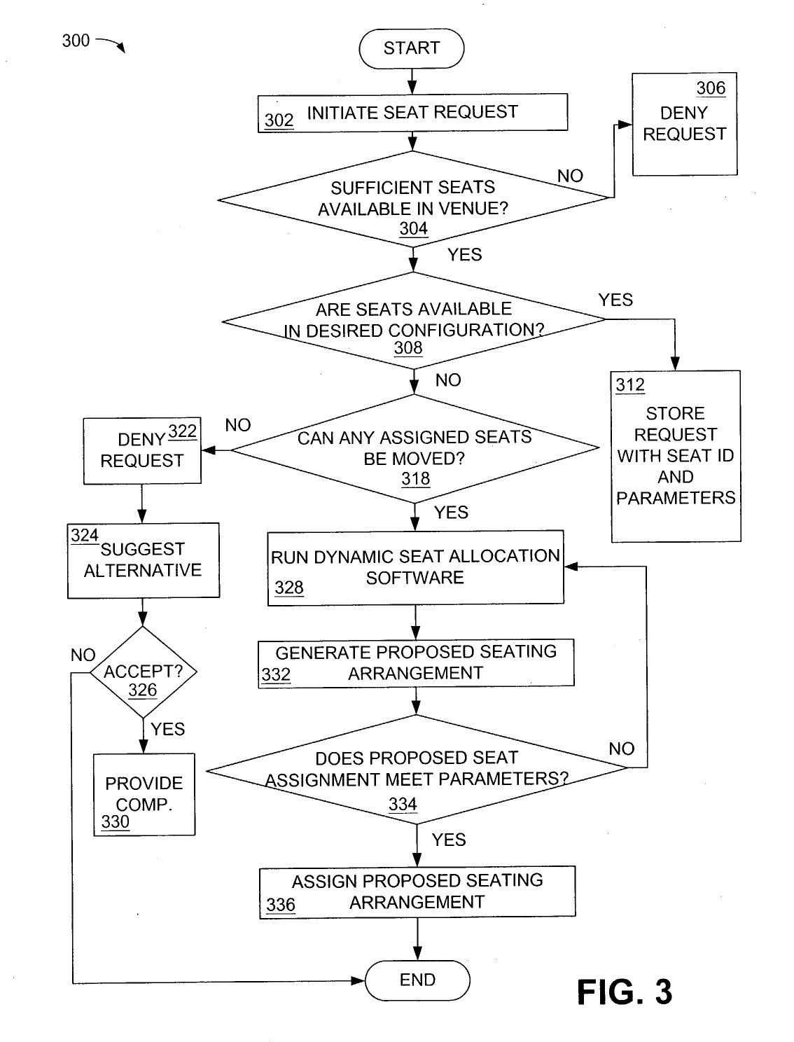

FIG. 3 is a flow chart illustrating an example of the operation of a first embodiment of the dynamic seat allocation software of FIG. 2. Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The description of the flow chart 300 assumes that an initial seat request has been placed and filled by a seat reservation system operating on the server computer 200. The seating request may include a number of parameters selected by the purchaser. For example, the purchaser may desire a number of seats in a particular configuration, such as all seats in a single row. However, the initial seating request may also be flexible in such parameters. For example, the initial seating request may only specify a number of seats in a particular section, or over a number of rows. If the purchaser sets such parameters, these parameters will be considered when a subsequent seating request is received.

In block 302 a subsequent seat request is initiated. This can occur, for example, by a user of the computer 102 of FIG. 1 logging onto the server computer 200 via the network 110 and accessing a web location 134 maintained on the server computer 200. In block 304 it is determined whether there are sufficient seats available in the particular venue and on the particular day and for the particular event to satisfy the subsequent purchase request. If sufficient seats are not available, then, in block 306 the request is denied and a message denying the request is returned to the user of the computer 102.

If, however, there are sufficient seats available in the venue, then, in block 308 it is determined whether there are seats available in the configuration desired by the user, which was communicated during the seat request in block 302. If, in block 308, it is determined that sufficient seats are available in the desired configuration, then, in block 312, the request is stored with a seat identifier and any specific seat parameters requested by the purchaser.

For example, if the purchaser did not specify a restrictive seating configuration, and there are sufficient seats, the system will log the seat reservation. A receipt is then returned to the purchaser via the computer 102. For example, the receipt can be printed out at the computer 102, and may include a bar code identifier, which the user can then take to the venue at the time of the event to gain access to the venue and retrieve a seat assignment.

If, however, in block 308 it is determined that there is an insufficient number of seats available in the purchaser's desired configuration, then, in block 318, it is determined whether any previously assigned seats can be rearranged. In order to determine whether assigned seats can be rearranged, the dynamic seat allocation software 210 analyzes existing seat requests and associated parameters to determine whether any of those requests allow the dynamic seat allocation software 210 to reorganize the seats to accommodate the subsequent request. This would be one of the parameters communicated during the initial seat request.

If, in block 318 it is determined that there are no seats that may be moved, then, in block 322, the server computer 200 denies the request in block 322 and suggests an alternative seating arrangement in block 324. This alternative seating arrangement is communicated back to the purchaser via the computer 102. The alternative seating arrangement offered in block 324 may be another seating configuration, or may be to divide the seats over different sections. Further, the alternative seating arrangement may also include an incentive to the user. For example, because the alternative seating arrangement may not be the one preferred by the user, an incentive, such as a coupon for free or reduced cost concessions, may be offered to the user in exchange for accepting the alternative seating arrangement. Other incentives, such as, for example, a discounted ticket price, may also be offered as incentive.

In block 326, the user decides whether to accept the alternative seating arrangement suggested in block 324. If the user decides not to accept the alternative, then the process ends. However, if the user decides to accept the alternative seating arrangement offered in block 324, the incentive is provided in block 330.

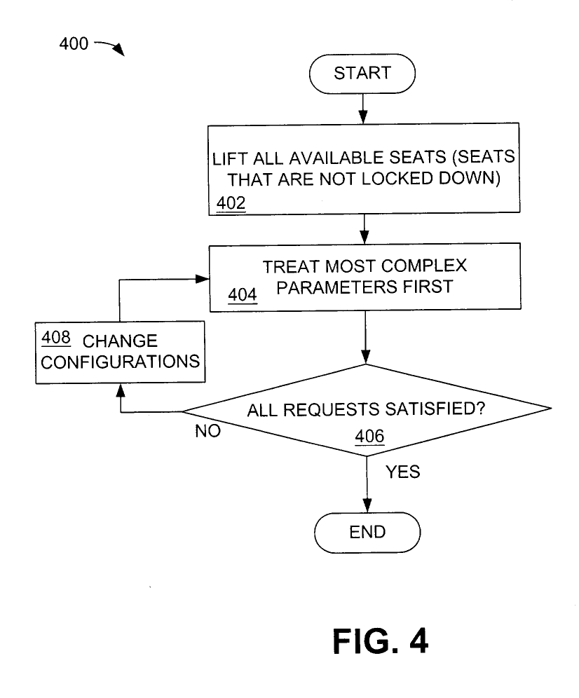

If, however, in block 318 it is determined that at least one existing seat configuration can be reorganized, then, in block 328, the dynamic seat allocation software 210 is initiated and executed. The operation of the dynamic seat allocation software in block 328 will be described in FIG. 4.

In block 332, the dynamic seat allocation software 210 generates a proposed revised seating arrangement. The proposed seating arrangement includes the reassignment of previously reserved seats in order to accommodate both the previous seating request and the subsequent seating request. The proposed revised seating arrangement attempts to satisfy all seating parameters of the initial and subsequent seating requests, while minimizing the number of fragmented single seats in the overall venue.

In block 334 it is determined whether the proposed revised seat arrangement satisfies the requested parameters. These are the parameters that were communicated by the purchaser in block 302. If the proposed revised seating arrangement does not meet the desired parameters, then, in block 328 the dynamic seat allocation software 210 is again executed and the process is repeated in an attempt to obtain improved results. This process can be repeated until the number of isolated seats is minimized and subsequent executions of the dynamic seat allocation software 210 fail to reduce the number of isolated seats while satisfying all of the requested seating parameters.

If, however, in block 334 it is determined that the proposed revised seating arrangement meets all parameters, then, in block 336, the proposed revised seating arrangement becomes the new assigned seating arrangement and the process ends. FIG. 4 is a flow chart illustrating an example of the operation of the dynamic seat allocation software 210 as described in block 328 of FIG. 3. In block 402, the dynamic seat allocation software determines which seats in the venue parameter table 215 are subject to reorganization. In other words, the dynamic seat allocation software 210 determines which seats are not “hard assigned” and makes those seats available for reorganization.

In block 404 all of the parameters for each seating request are analyzed and the most complex seating parameters are treated before treating less complex seating parameters. In block 406 it is determined whether all seating requests have been satisfied, meaning that all parameters for all seating requests are satisfied. If all seating requests have not been satisfied, then, in block 408, the seating configuration is again changed and the process is repeated. However, if all seating requests have been satisfied in block 406, then the process ends.

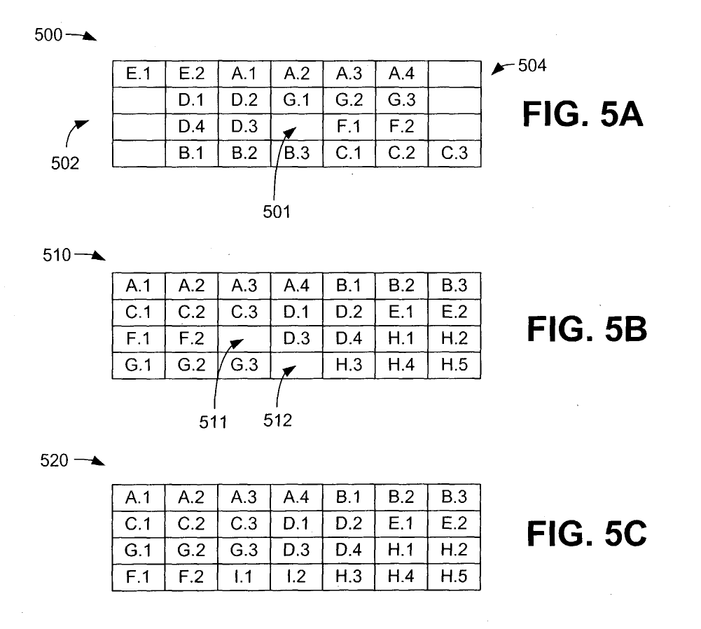

FIGS. 5A through 5C are graphical illustrations collectively illustrating three scenarios that describe the results obtained by the dynamic seat allocation software 210 of FIG. 2. In FIG. 5A, the seating matrix 500 is representative of a number of seats in a section of a venue and illustrates how a traditional seating reservation system works. Each box represents one available or assigned seat. Seating defragmentation occurs when a seat is selected and assigned to the ticket purchaser at the point and time of sale. In this example, the letters represent a party and the numbers represent the seats of each party being filled in numerical order. For example, party A has been assigned four seats in the top row of the seating matrix 500, resulting in a single available seat at one end of the top row. Party B has been assigned three seats in the bottom row of the seating matrix, with another single seat available in the bottom row. Subsequent orders C, D, E, F and G are filled as received, resulting in assigned seats surrounding single seat 501 and single seats in different rows illustrated using reference numerals 502 and 504. Unfortunately, when seating is filled in this manner, a large number of single seats result, thereby preventing groups of two or more from sitting together, and generally resulting in a large number of unsold seats.

In FIG. 5B, seating matrix 510 illustrates the result of executing the dynamic seat allocation software 210 when new party H requests seats. As shown, the seats assigned to parties A, B, C, D, E and F have been reorganized so that party H, which includes a request for five seats, can be filled as shown. This in turn, results in only two single seats 511 and 512 available after party H has been assigned seats. However, this seating arrangement shown in FIG. 5B still prevents a final party of two from obtaining adjoining seats and sitting together.

In FIG. 5C, seating matrix 520 illustrates another execution of the dynamic seat allocation software 210 in which new party I is accommodated. In this manner, single seats are eliminated and by dynamically allowing seating to be rearranged, the number of unsold seats can be minimized.

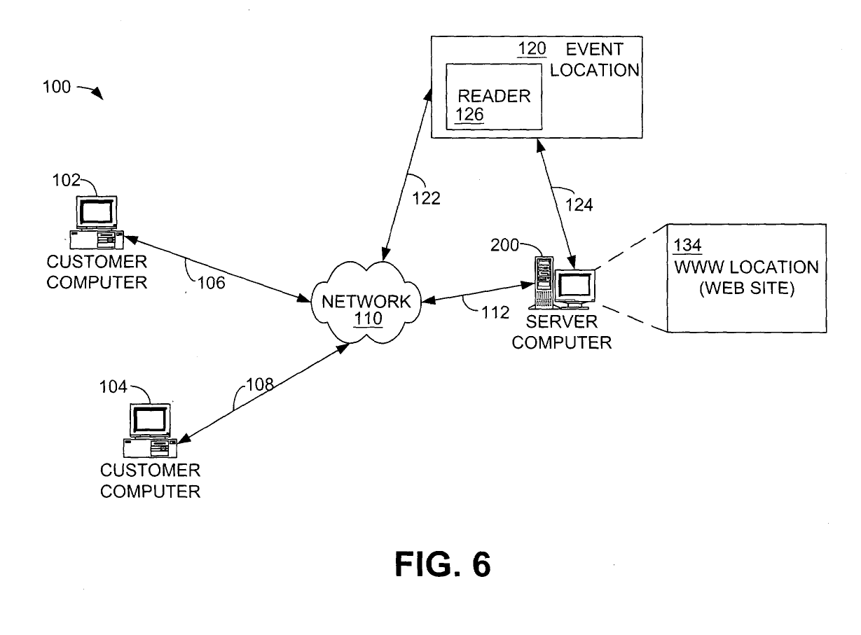

FIG. 6 is a schematic diagram illustrating an example of an alternative embodiment of the dynamic seat allocation software of FIG. 2. FIG. 6 is similar to FIG. 1 except that an event location 120 is added. The event location 120 can be coupled to the network 110 via connection 122 and/or can be coupled directly to the server computer 200 via connection 124. In this embodiment, the event location 120 communicates with the server computer 200 either via the network 110 or via a direct connection 124.

In this embodiment, a purchaser arrives at the event location 120 with a ticket receipt having, for example, a bar code identifier. When the purchaser arrives at the event location 120, the bar code receipt is read by a reader 126 at the event location 120. For example the reader 126 may be a scanner configured to read a barcode. The seating arrangement for the receipt is assigned directly at the event location 120 in cooperation with the dynamic seat allocation software 210 executing on the server computer 200. In this manner, the seating can remain flexible up until the time that the venue is opened for the event.

In an alternative embodiment, prior to seat assignment, the purchaser may be offered a seat upgrade at the event location. For example, if there are unsold seats available that normally sell for more than the cost of the seats purchased by the purchaser, the dynamic seat allocation software 210 executing on the server computer 200 may offer the purchaser one of these more expensive seats at, for example, a discounted price. This embodiment benefits the customer by offering the customer an upgraded seat at a discounted price, and benefits the event location by allowing the sale of a seat that would have gone unsold.

It will be apparent to those skilled in the art that many modifications and variations may be made to the preferred embodiments of the present invention, as set forth above, without departing substantially from the principles of the present invention. For example, the system and method for dynamic seat allocation can be executed only during the time that tickets are sold. Alternatively, the system and method for dynamic seat allocation can be executed continually until the time of the event and in cooperation with the event venue to dynamically assign seats up until the event occurs. Further, the system and method for dynamic seat allocation can set the price of the requested tickets based on how restrictive the seating request is. For example, a request for a seat “anywhere in the stadium” would be the least costly. In such an arrangement, the system could rearrange those seats throughout the venue as subsequent seating requests arrive. The ticket cost could progressively increase as the user reduces the possible number of acceptable seats until a premium seating arrangement is reached, such as when a user picks a specific seat at the time of purchase. All such modifications and variations are intended to be included herein within the scope of the present invention, as defined in the claims that follow.

What is claimed is:

1. A system for dynamically allocating seat assignments, comprising:
a matrix having a plurality of available seats;
a first seating arrangement using fewer than the entire plurality of available seats, the first seating arrangement based on a first seating request;
a subsequent seating request; and
logic for revising the first seating arrangement to develop a proposed seating arrangement to accommodate the first seating request and the second seating request.

2. The system of claim 1, wherein the logic minimizes a number of single seats in the matrix.

3. The system of claim 1, wherein the logic further comprises a software module that:
deassigns seats in the first seating arrangement;
reassigns seats in the first seating arrangement;
assigns seats in the subsequent seating request; and
generates the proposed seating arrangement to satisfy the first seating request and the second seating request.

4. The system of claim 3, wherein the first and second seating requests further comprise seating parameters, the seating parameters configured to define whether seats in the first seating arrangement can be reorganized.

5. The system of claim 3, further comprising a printer for printing an electronic receipt for the proposed seating arrangement.

6. The system of claim 5, further comprising:
a reader located at an event facility and configured to receive the receipt; and
logic configured to assign a seat at the event facility.

7. The system of claim 6, wherein the logic offers a seat upgrade.

8. A method for dynamically allocating seat assignments, comprising:
providing a plurality of available seats in a matrix;
establishing a first seating arrangement using fewer than the entire plurality of available seats based on a first seating request;
receiving a subsequent seating request; and
revising the first seating arrangement to develop a proposed seating arrangement to accommodate the first seating request and the second seating request.

9. The method of claim 8, wherein the revising further comprises minimizing a number of single unreserved seats in the matrix.

10. The method of claim 8, wherein the revising further comprises:
executing a software module that deassigns seats in the first seating arrangement;
reassigning seats in the first seating arrangement;
assigning seats in the subsequent seating request; and
generating the proposed seating arrangement to satisfy the first seating request and the second seating request.

11. The method of claim 10, wherein the generating is performed based on parameters associated with the first seating request and the second seating request.

12. The method of claim 10, further comprising printing an electronic receipt for the proposed seating arrangement.

13. The method of claim 12, further comprising:
receiving the receipt at a reader located at an event facility; and
assigning a seat at the event facility.

14. The method of claim 13, further comprising offering a seat upgrade.

15. A computer readable medium having a program for dynamically allocating seat assignments, the program comprising logic for:
providing a plurality of available seats in a matrix;
establishing a first seating arrangement using fewer than the entire plurality of available seats based on a first seating request;
receiving a subsequent seating request; and
revising the first seating arrangement to develop a proposed seating arrangement to accommodate the first seating request and the second seating request.

16. The program of claim 15, wherein the logic for revising further comprises logic for minimizing a number of single unreserved seats in the matrix.

17. The program of claim 15, wherein the logic for revising further comprises logic for:
executing a software module that deassigns seats in the first seating arrangement;
reassigning seats in the first seating arrangement;
assigning seats in the subsequent seating request; and
generating the proposed seating arrangement to satisfy the first seating request and the second seating request.

18. A system for dynamically allocating seat assignments, comprising:
means for providing a plurality of available seats in a matrix;
means for establishing a first seating arrangement using fewer than the entire plurality of available seats based on a first seating request;
means for receiving a subsequent seating request; and
means for revising the first seating arrangement to develop a proposed seating arrangement to accommodate the first seating request and the second seating request.

19. The system of claim 18, wherein the revising means comprises means for minimizing a number of single unreserved seats in the matrix.

20. The method of claim 18, wherein the revising means further comprises:
means for executing a software module that deassigns seats in the first seating arrangement;
means for reassigning seats in the first seating arrangement;
means for assigning seats in the subsequent seating request; and
means for generating the proposed seating arrangement to satisfy the first seating request and the second seating request.
